(19) United States
(12) Patent Application Publication
(10) Pub. No.: US 2020/0159929 A1
(43) Pub. Date: May 21, 2020

(54) BASIC INPUT/OUTPUT SYSTEM UPDATES

(71) Applicant: HEWLETT-PACKARD DEVELOPMENT COMPANY L.P., Spring, TX (US)

(72) Inventors: Christopher H Stewart, Houston, TX (US); Baraneedharan Anbazhagen, Houston, TX (US); Lan Wang, Houston, TX (US); Stanley Hyojun Park, Houston, TX (US); Vali Ali, Houston, TX (US); Wei Ze Liu, Houston, TX (US); Mark A Piwonka, Houston, TX (US)

(21) Appl. No.: 16/478,986

(22) PCT Filed: Aug. 8, 2017
(86) PCT No.: PCT/US2017/045856

§ 371 Date: Jul. 18, 2019

(51) Int. Cl. G06F 21/57; G06F 21/60; G06F 9/4401; G06F 8/654

(52) U.S. Cl. CPC G06F 21/572; G06F 8/654; G06F 9/4401; G06F 21/602

(57) ABSTRACT

Examples associated with basic input/output system (BIOS) up-dates are described. One example method includes system management mode locking a first pre-extensible firmware interface initialization (PEI) region and a driver execution environment (DXE) region of a shared serial peripheral (SPI) chip of a BIOS of a computer. A second PEI region of the shared SPI chip is chipset locked. A record in a system management random access memory associated with a video option read only memory (ROM) is created. The video option ROM is loaded. The first PEI region is updated, and periodic graphical updates regarding the progress of updating the first PEI region are provided using the video option ROM.

### BACKGROUND

The basic input/output system of a computer includes system firmware that is used by the computer to boot the computer, identify and communicate with connected hardware components, and for performing a variety of services for the computer's operating system and other applications once the system is operating. Occasionally, it is desirable to update a BIOS of a system to improve performance of the system, provide it with new functionality, protect the system and/or the BIOS against malicious attacks, and so forth.

### BRIEF DESCRIPTION OF THE DRAWINGS

The present application may be more fully appreciated in connection with the following detailed description taken in conjunction with the accompanying drawings.

FIG. 1 Illustrates components of an example basic input/output system (BIOS).

FIG. 2 illustrates a flowchart of example operations associated with BIOS updates.

FIG. 3 illustrates an example system associated with BIOS updates.

FIG. 4 illustrates another example system associated with BIOS updates.

FIG. 5 illustrates another flowchart of example operations associated with BIOS updates.

FIG. 6 illustrates an example computing device in which example systems, and methods, and equivalents, may operate.

### DETAILED DESCRIPTION

Systems, methods, and equivalents associated with basic input/output system (BIOS) updates are described. One challenge of implementing effective security is to make it user friendly. A BIOS update is one example of this. When a user updates the BIOS of their computer, often, the user is eventually directed to reboot their computer, at which point the user may sit uncomfortably at their computer staring at a blank screen for several moments while certain pre-video portions of the BIOS update themselves. Video support is sometimes delayed until later in the BIOS update process to avoid running unsecure third party code that might include malicious code or be otherwise vulnerable to malicious code. In some cases, if the user believes nothing has happened for a prolonged period, the user may restart the computer before completion of the update, which may at best restart the update process.

Consequently, it may be desirable to provide visual updates to a user regarding the BIOS update process for as much of the process as possible. One challenge with this goal is ensuring that all code run during the update process is trusted and/or secure. Additionally, it may be desirable to ensure that certain portions of the BIOS are updated prior to others. Thus, in examples described herein, a process is disclosed for providing graphical updates during a phase of updating the pre-extensible firmware interface initialization (PEI) regions of a shared serial peripheral interface (SPI) BIOS chip as well as a backup copy of one or more of these regions on a secure embedded controller while maintaining the property that updates to the SPI should be completed before starting updates to the embedded controller.

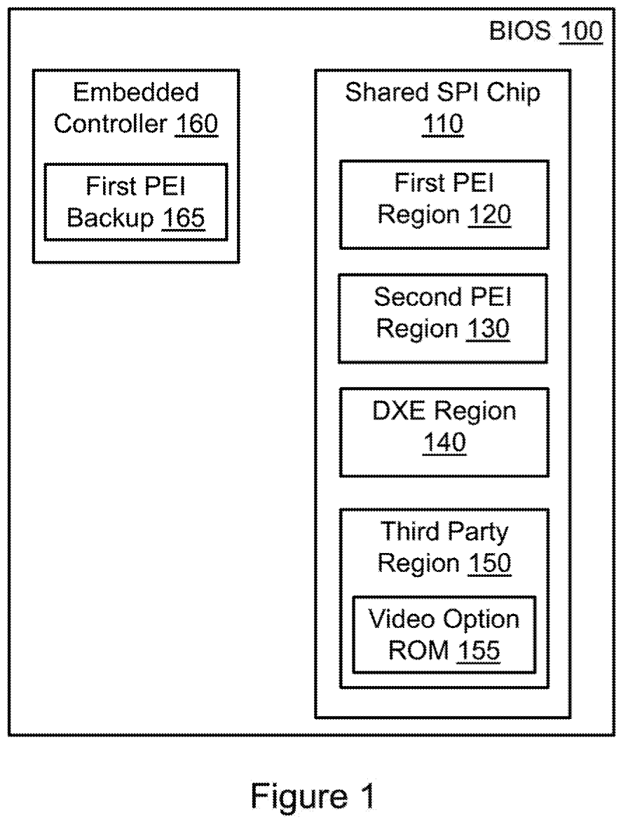

FIG. 1 illustrates an example basic input/output system (BIOS), it should be appreciated that the items depicted in FIG. 1 are illustrative examples, and many different systems, devices, components and so forth, may operate in accordance with various examples.

FIG. 1 illustrates an example BIOS 100. BIOS 100 includes a shared SPI chip 110. Shared SPI chip 110 includes a first pre-extensible firmware interface initialization (PEI) region 120, a second PEI region 130, and a driver execution environment region DXE 140. When the BIOS is not in a state preparing for an update, these regions may store instructions associated with starting up a computer in which BIOS 100 is embedded. Shared SPI chip 110 also includes a third party region 150 for storing instructions associated with operating and communicating with devices and/or components once certain initial setup tasks and security measures have been performed. In this example, third party region 150 stores a video option read only memory (ROM) 155 that may allow BIOS 100 to provide graphical support under certain circumstances (e.g., before the system has loaded a driver for a video card or attached display).

BIOS 100 also includes an embedded controller 160. Embedded controller 160 may facilitate performing a variety of security functions associated with BIOS 100 and the system in which BIOS 100 is embedded. For example, embedded controller 160 may verify that various portions of BIOS 100 have not been compromised by a malicious entity and/or will otherwise operate properly before those portions are allowed to act. When an error is found, embedded controller 160 may initiate a remedial action such as restoring a compromised BIOS 100 component having an invalid state to a prior valid state. By way of illustration, embedded controller 160 stores a first PEI backup 165 so that embedded controller 160 can check the validity of first PEI region 120 and restore first PEI region 120 in the event an inconsistency is found.

When there s a pending update to BIOS 100 that affects the instructions on the shared SPI regions, that update may initially be pushed to second PEI region 130 and DXE region 140. The system including BIOS 100 may then be restarted, and during the boot process, embedded controller 160 may detect the updated instructions. Specifically, embedded controller 160 may detect that second PEI region 130 has a new version of instructions that also matches a version of instructions in DXE region 140, whereas first PEI region 120 may have an older version of instructions. When this occurs, and when embedded controller 160 is otherwise assured about the validity of the update, embedded controller 160 may hand off execution control to the instructions in second PEI region 130 so that the rest of the BIOS update can be completed, including, for example, updating first PEI region 120 based on instructions in a system management mode (SMM) BIOS update module (not shown).

Once second PEI region 130 obtains execution control, second PEI region 130 may SMM lock first PEI region 120 and DXE region 140. Second PEI region 130 may also chipset lock itself. These locks may hinder malicious code from acting on these sensitive regions while instructions from these regions are executing by limiting modification access to these regions. Once the locks are in place, second PEI region 130 may allow instructions from DXE region 140 to begin executing.

The instructions on DXE region 140 may continue readying the update to BIOS 100, and will eventually reach an end of DXE state after which certain third party instructions are allowed to execute because a system management random access memory (SMRAM) of the BIOS will be locked and secure. Prior to reaching the end of DXE state, the DXE instructions may search shared SPI chip 110 for video option ROM 155, as well as other connected on-board devices such as a PCI video card (not shown). As discussed above, in this example, video option ROM 155 is in third party region 150 of shared SPI chip 110. When video option ROM 155 is found, DXE instructions may verify trust for video option ROM 155. In various examples, video option ROM 155 may be considered trusted when it is validly signed using a key trusted by BIOS 100. A key may be trusted when BIOS 100 has or is capable of verifying the key at runtime, the key is in a region of shared SPI chip 110 (e.g., DXE region 140) signed by a key belonging to a manufacturer of BIOS 100, and so forth. In another example, when video option ROM 155 is stored in DXE region 140, and DXE region 140 has been signed by a trusted key, then video option ROM 155 may be treated as trusted by BIOS 100. Other versions of trust may also be appropriate for validating trust of video option ROM 155.

When a trusted video option ROM 155 is found, a record associated with video option ROM 155 may be created and stored to facilitate loading the video option ROM during an upcoming phase of the BIOS update. The record may be created in SMRAM. The record may include a device path to video option ROM 155 describing a location of video option ROM 155 on shared SPI chip 110. The record may also include a hash of video option ROM 155 to facilitate verification that a malicious change to video option ROM 155 is not made between the verification of video option ROM 155 and loading video option ROM 155. In the event that no video option ROM is found, or video option ROM 155 is found but trust cannot be verified for video option ROM 155, a NULL record entry may be created in SMRAM. The null record entry may serve to prevent loading of video option ROMs during the process of updating first PEI region 120.

Whether a null record, or a record associated with video option ROM 155 is created, eventually an end of DXE state will be triggered. This may cause the SMRAM to be locked so that a secure updating of first PEI region 120 may proceed. SMM instructions may then begin the process of loading contents of second PEI region 130, and transforming the contents into what will eventually be stored in first PEI region 120. Potentially concurrent with the transformation, other instructions from DXE region 140 may request the option ROM record from an SMM BIOS update module. If a null record is returned by the SMM BIOS update module, then no video option ROM will be loaded and the BIOS update will continue without video. However, if a record associated with video option ROM 155 is found, DXE instructions may load video option ROM 155 into a data buffer, and pass a pointer to the data buffer to the SMM BIOS update module.

The SMM BIOS update module may then generate a new hash of the copy of video option ROM 155 loaded in the data, buffer, and compare that to the hash of video option ROM 155 from the record. When the two hashes match, the SMM BIOS update module may confirm validity of video option ROM 155, allowing the DXE instructions to load video option ROM 155 for use. If the two hashes do not match the SMM BIOS module may indicate that video option ROM 155 is invalid, causing no video option ROM to be loaded, and the BIOS update to proceed without video. Whether verification succeeds or fails, the SMM BIOS update module may begin updating first PEI region 120 with instructions it has transformed from second PEI region 130. For cases where verification of video option ROM 155 succeeded, the record of verified video option ROM 155 may cause the BIOS update module to send a periodic notification to a process (e.g., based on DXE instructions) providing graphical updates to a user via a display. These graphical updates may include, for example, displaying a progress bar, a percent completion rate, a task being performed, debugging information, and so forth, on a display connected to a system in which BIOS 100 is embedded.

In other examples, the record associated with video option ROM 155 may be generated without a hash, and trust for video option ROM 155 may be validated prior to reaching the end of DXE state. In these examples, a record associated with video option ROM 155 will cause the SMM BIOS update module to load video option ROM 155 without an additional check. This may speed up the process of loading video option ROM 155. If a NULL record is found instead by the SMM BIOS update module, the update may proceed without video support for this phase.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

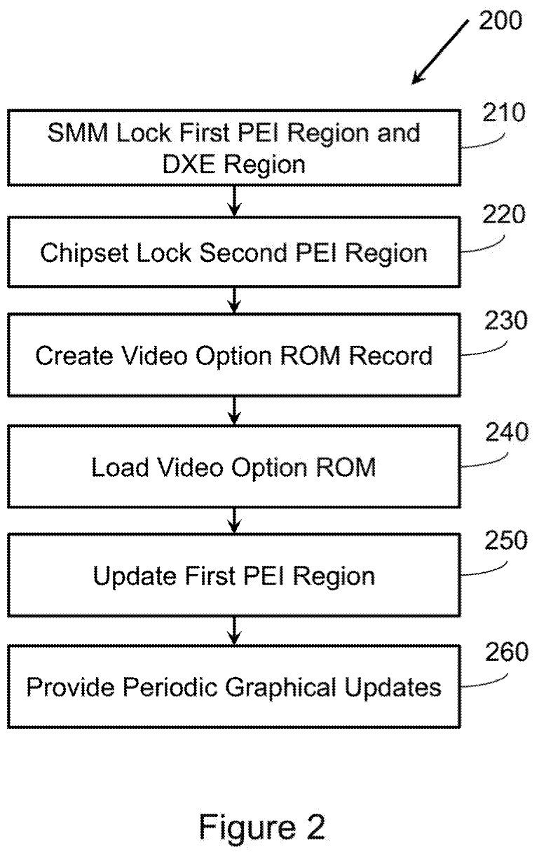

FIG. 2 illustrates an example method 200. Method 200 may be embodied on a non-transitory processor-readable medium storing processor-executable instructions. The instructions, when executed by a processor, may cause the processor to perform method 200. In other examples, method 200 may exist within logic gates and/or RAM of an application specific integrated circuit (ASIC).

Method 200 may perform various tasks associated with basic input/output system (BIOS) updates. Method 200 includes, at 210, system management mode (SMM) locking a first pre-extensible firmware interface initialization (PEI) region and a driver execution environment (DXE) region of a shared serial peripheral interface (SPI) chip of a BIOS of a computer.

Method 200 also includes chipset locking a second PEI region of the shared SPI chip at 220. In some examples, method 200 may also include verifying DXE instructions stored in the DXE region of the SPI chip (not shown). The instructions in the DXE region may be verified based on instructions stored in the second PEI region. The verification may be performed by, for example, comparing a stored hash to a generated hash of instructions in the DXE region, ensuring a version match between instructions in the second PEI region and instructions in the DXE region (e.g., based on version numbers contained in a metadata region signed by a key trusted by the BIOS), and so forth.

Method 200 also includes creating a record in system management random access memory (SMRAM) at 230. The record may be associated with a video option read only memory (ROM). The record associated with the video option ROM may be created when the video option ROM is trusted by the BIOS. When no trusted video option ROM is found, a null video option ROM record may be created instead. A video option ROM may be trusted when the video option ROM is validly signed by a key trusted by the BIOS. A key may be trusted by the BIOS, for example, when it was provided by a manufacturer of the BIOS, and so forth.

Method 200 also includes loading the video option ROM at 240. In some examples, the video option ROM record may include a pointer to the video option ROM and a first hash of the video option ROM. Thus, prior to loading the video option ROM, a SMM module may generate a second hash of the video option ROM and verify the second hash against the first hash of the video option ROM. When the two hashes match, the video option ROM may be verified and therefore safe to load. If there is a mismatch, the video option ROM may not be loaded because it could potentially include malicious instructions.

Method 200 also includes updating the first PEI region at 250. Updating the first PEI region may include loading instructions from the second PEI region, transforming these instructions, and storing the transformed instructions in the first PEI region. This process may be performed using differential data associated with the BIOS update.

Method 200 also includes periodically providing graphical updates at 260. The graphical updates may describe the progress of updating the first PEI region at action 250. The graphical updates may be provided using the video option ROM. By way of illustration, the video option ROM may facilitate graphical display of, for example, a progress bar, a percentage, a task being completed, an estimated time to completion, and so forth so that a user waiting for the BIOS update process to complete is aware that progress is being made and to not interrupt the update process.

In some examples, method 200 may be initiated after an embedded controller detects a pending, valid update BIOS update. In this example, the embedded controller may give execution control the second PEI region, where in a non-update scenario, execution control would be given to the first PEI region. In this example, the embedded controller may store a backup copy of instructions in the first PEI region. Thus, updating the first PEI region may include copying the transformed instructions to the embedded controller.

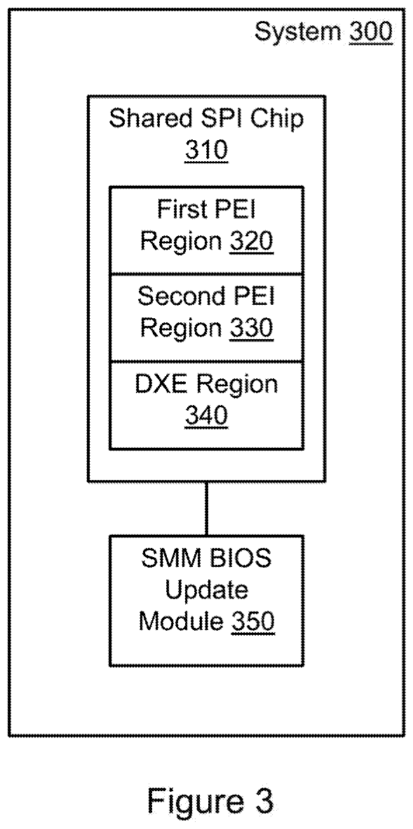

FIG. 3 illustrates an example system 300 associated with basic input/output system (BIOS) updates. System 300 includes BIOS (not shown) with a shared serial peripheral interface (SPI) chip 310. Shared SPI chip 310 includes a first pre-extensible firmware interface initialization (PEI) region 320, a second PEI region 330, and a driver execution environment (DXE) region 340. DXE region 340 may include instructions for searching shared SPI chip 310 for a video option read only memory (ROM). The instructions may also facilitate creating a record for the video option ROM in a system management random access memory (SMRAM). The record may be created after verifying trust for the video option ROM. When no trusted video option ROM is found on the shared SPI, a null record may be created. A trusted video option ROM may be a video option ROM that is validly signed by a key trusted by the BIOS. The instructions may also facilitate signaling an end of DXE state.

Second PEI region 330 may include instructions for system management mode (SMM) locking the DXE region 340 and first PEI region 320. These instructions may also include chipset locking second PEI region 330. The instructions may also include initiating execution of instructions on DXE region 340.

System 300 also includes an SMM BIOS update module 350. While in this example, SMM BIOS update module is illustrated as existing exterior to shared SPI chip 310, in other examples, SMM BIOS update module 350 may reside within shared SPI chip 310, a component thereof, within another component of the BIOS of system 300, and so forth. SMM BIOS update module 350 may update instructions stored in first PEI region 320. Updating the instructions stored in first PEI region 320 may include creating a copy of instructions stored in second PEI region 330, transforming the copy of the instructions from second PEI region 330, and storing the transformed copy in first PEI region 320.

Prior to updating first PEI region 320, SMM BIOS update module 350 may use the record for the video option ROM to load the video option ROM after verifying trust of the video option ROM. When the video option ROM is loaded, SMM BIOS update module 350 may use the video option ROM to provide periodic graphical updates regarding the progress of updating first PEI region 320.

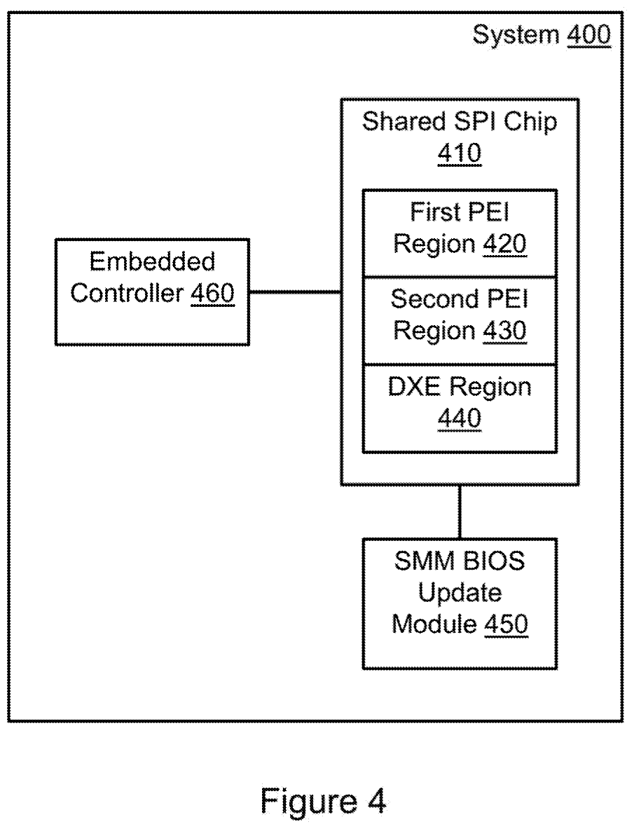

FIG. 4 illustrates a system 400 associated with basic input/output system (BIOS) updating. System 400 includes several items similar to those described above with reference to system 300 (FIG. 3). For example, system 400 includes a SMM BIOS update module 450 and a shared SPI chip 410 having a first PEI region 420, a second PEI region 430, and a DXE region 440.

System 400 also includes an embedded controller 460. Embedded controller 460 may initiate execution of instructions in second PEI region 430. The instructions may be initiated when embedded controller 460 detects a pending valid BIOS update by examining first PEI region 420, second PEI region 430, and DXE region 440. Embedded controller 460 may also store a backup copy of first PEI region 420. Thus, after SMM BIOS update module 450 completes updating first PEI region 420, embedded controller 460 may backup instructions that SMM BIOS update module 450 has stored in first PEI region 420.

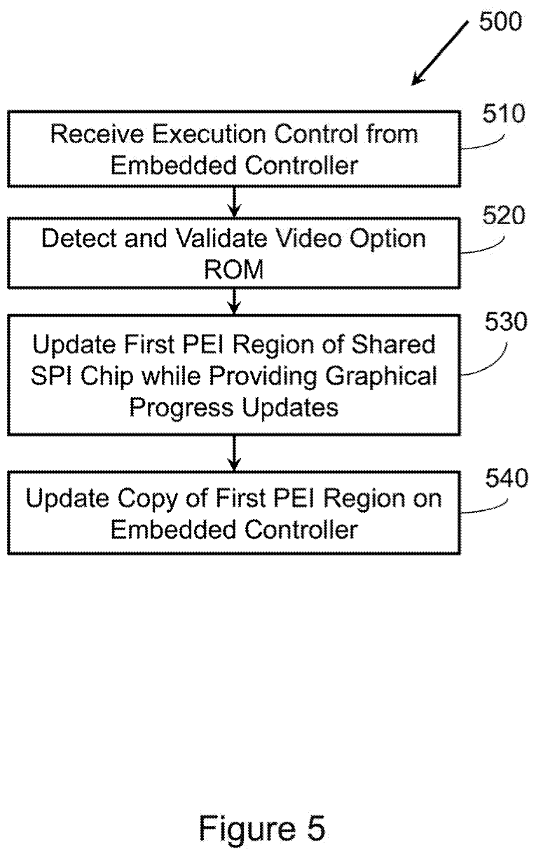

FIG. 5 illustrates a method 500 associated with basic input/output system updates. Method 500 includes receiving execution control from an embedded controller at 510. Execution control may be received when the embedded controller detects a pending and valid BIOS update.

Method 500 also includes detecting and validating a video option read only memory (ROM) at 520. The video option ROM may be stored on a shared serial peripheral interface (SPI) chip of a BIOS, on an external device, and so forth. When on an external device, the option ROM may be signed by a key trusted by the BIOS.

Method 500 also includes, at 530, updating a first pre-extensible firmware interface initialization (PEI) region of the shared SPI chip based on a second PEI region of the shared SPI chip. While the update is occurring, periodic graphical updates regarding the progress of updating the first PEI may be provided using the video option ROM.

Method 500 also includes updating a backup copy of he first PEI region on the embedded controller at 540. The backup copy may be updated after completing the update of the first PEI region at action 530.

In some examples, method 500 may include system management mode (SMM) locking the first PEI region and a driver execution environment (DXE) region of the shared SPI chip. Additionally, the second PEI, region of the shared SPI chip may be chipset locked. These locks may facilitate securing the shared SPI from malicious attacks during the pre-update and update process.

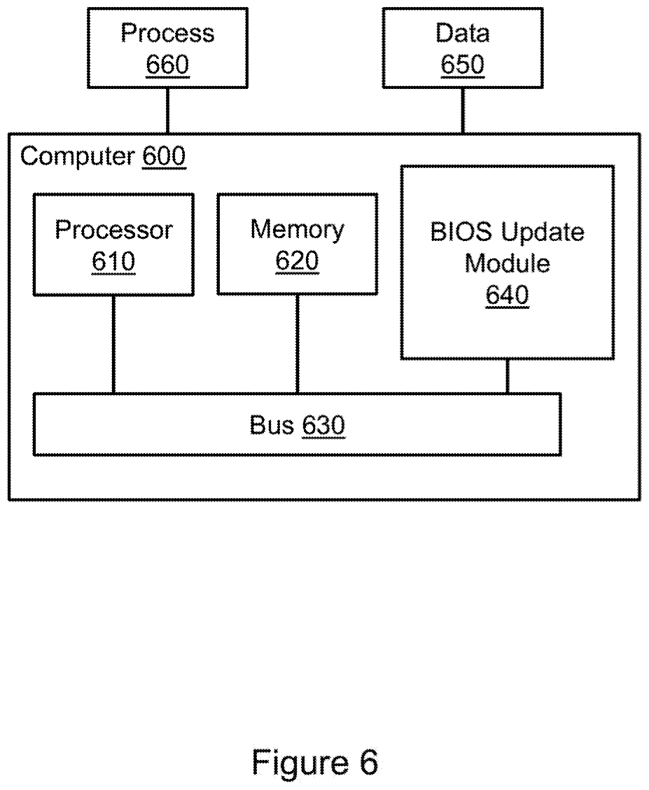

FIG. 6 illustrates an example computing device in which example, systems and methods, and equivalents, may operate. The example computing device may be a computer 600 that includes a processor 610 and a memory 620 connected by a bus 630. Computer 600 includes a basic input/output system (BIOS) update module 640. BIOS update module 640 may perform, alone or in combination, various functions described above with reference to the example systems, methods, and so forth. In different examples BIOS update module 640 may be implemented as a non-transitory computer-readable medium storing processor-executable instructions, in hardware, software, firmware, an application specific integrated circuit, and/or combinations thereof.

The instructions may also be presented to computer 600 as data 650 and/or process 660 that are temporarily stored in memory 620 and then executed by processor 610. The processor 610 may be a variety of processors including dual microprocessor and other multi-processor architectures. Memory 620 may include non-volatile memory (e.g., read-only memory) and/or volatile memory (e.g., random access memory). Memory 620 may also be, for example, a magnetic disk drive, a solid state disk drive, a floppy disk drive, a tape drive, a flash memory card, an optical disk, and so on. Thus, memory 620 may store process 660 and/or data 650. Computer 600 may also be associated with other devices including other computers, devices, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
system management made (SMM) locking a first pre-extensible firmware interface initialization (PEI) region and a driver execution environment (DXE) region of a shared serial peripheral interface (SPI) chip of a basic input/output system (BIOS) of a computer:
chipset locking a second PEI region of the shared SPI chip;
creating a record in a system management random access memory (SMRAM) associated with a video option read only memory (ROM);
loading the video option ROM;
updating the first PEI region; and
providing periodic graphical updates regarding the progress of updating the first PEI region using the video option ROM.

2. The method of claim 1, where the record associated with the video option ROM is created when the video option ROM is trusted by the BIOS, and where a null record is created when no trusted video option ram is found.

3. The method of claim 2, where the video option ROM is trusted when the video option ROM is validly signed by a key trusted by the BIOS.

4. The method of claim 1, where the record associated with the video option ROM includes a pointer to the video option ROM and a first hash of the video option ROM.

5. The method of claim 4, where the video option ROM is loaded when a SMM module generates a second hash of the video option ROM and verifies the second hash against the first hash of the video option ROM.

6. The method of claim 1, comprising verifying, based on instruct n stored in the second PEI region, DXE instructions stored in the DXE region.

7. The method of claim 1, where updating the first PEI region comprises loading instructions from the second PEI region, transforming the instructions loaded from the second PEI region, and storing the transformed instructions in the first PEI region.

8. The method of claim 7, where the method is initiated after an embedded controller detects a pending, valid BIOS update and gives execution control to the second PEI region, where the embedded controller stores a backup of instructions in the first PEI region, and where updating the first PEI region includes copying the transformed instructions to the embedded controller.

9. A system, comprising:
a shared serial peripheral interface (SPI) chip of a basic input/output system of a computer, comprising:
a first pre-extensible firmware interface initialization (PEI) region;
a driver execution environment (DXE) region comprising instructions for searching the shared SPI chip for a video option read only memory (ROM), for creating a record for the video option ROM in a system management random access memory (SMRAM) after verifying trust for the video option ROM, and for signaling an end of DXE state;
a second PEI region comprising instructions for system management mode (SMM) locking the DXE region and the first PEI region, for chipset locking the second PEI region, and for initiating execution of instructions on the DXE region; and
a SMM BIOS update module to, based on the record for the video option ROM, load the video option ROM after verifying trust of the video option ROM, to update instructions stored in the first PEI region, and to periodically provide graphical updates regarding the progress of updating the PEI region when the video option ROM is loaded.

10. The system of claim 9, comprising an embedded controller to, during a boot of the system, after detecting a pending, valid BIOS update by examining the first PEI region, the second PEI region, and the DXE region, initiate execution of the instructions on the second PEI region, and to store a backup copy of the updated instructions stored in the first PEI region upon completion of the update to the instructions of the first PEI region.

11. The system of claim 9, where updating the instructions stored in the first PEI region includes creating a copy of instructions stored in the second PEI region, transforming the copy of the instructions, and storing the transformed copy in the first PEI region.

12. The system of claim 9, where a null record is created when no trusted video option ROM is found on the shared SPI.

13. The system of claim 12, where a trusted video option ROM is a video option ROM that is validly signed by a key trusted by the BIOS.

14. A non-transitory computer-readable medium having computer executable instructions stored thereon, where the computer executable instructions, when executed, control a computer to:
receive execution control from an embedded controller when the embedded controller detects a pending, valid basic input/output system (BIOS) update;
detect and validate a video option read only memory (ROM) stored on a shared serial peripheral interface (SPI) chip of a BIOS;
update a first pre-extensible firmware interface initialization (PEI) region of the shared SPI chip based on a second PEI region of the shared SPI chip while providing, using the video option ROM, periodic graphical updates regarding the progress of updating the first PEI; and
update a backup copy of the first PEI region on the embedded controller after completing the update of the first PEI region.

15. The non-transitory computer-readable medium of claim 14, where the instructions further cause the computer to:
system management mode (SMM) lock the first PEI region and a driver execution environment (DXE) region of the shared SPI chip; and
chipset lock the second PEI region of the shared SPI chip.
